(19) United States
(12) Patent Application Publication
(10) Pub. No.: US 2009/0134253 A1
(43) Pub. Date: May 28, 2009

(54) Shredder safety throat

(76) Inventor: Simon Huang, Taipei (TW)

Correspondence Address: Venable, 2049 Century Park East, 21st Floor, LOS ANGELES, CA, 90067, US

(21) Appl. No.: 11/998,026

(22) Filed: Nov. 28, 2007

(51) Int. Cl. B02C 23/04

(52) U.S. Cl. 241/37.5

(57) ABSTRACT

The present invention relates generally to shredder openings or throats. Specifically, this invention discloses a shredder safety throat which helps prevent injuries by tapering inwards towards the center section of the throat such that fingers and/or other objects that are not meant to be shredded cannot reach the shredding mechanism.

### BACKGROUND OF THE INVENTION

1. Field of the Invention

The present invention relates generally to the opening through which materials to be shredded are fed into shredders. Specifically, this invention discloses a shredder safety throat which helps prevent injuries by tapering inwards to prevent fingers and/or other objects that are not meant to be shredded from entering the shredding mechanism.

2. Background Information

With increased privacy concerns, shredders have become an integral part in both homes and businesses. Though originally used to destroy paper products, shredders are now used to shred other forms of media that hold information, such as compact discs. In addition, credit cards and other plastic products are commonly shredded.

The United States Consumer Product Safety Commission (“CPSC”) published a document entitled Paper Shredder Safety Alert (Document #5127, May 2004). According to this report in the 3 year period from January 2000 through December 2003, the CSPC received 31 reports involving finger amputations, lacerations, and other finger injuries from paper shredders.

In order to reduce the likelihood of such injuries, the present invention employs a shredder safety throat which prevents fingers or other foreign objects from reaching the shredding mechanism while readily accepting material to be shredded.

One preferred embodiment of the claimed invention provides this by having a throat entrance and exit that is wider than the middle portion of the throat. This tapered, hourglass shaped throat prevents fingers and foreign objects from passing through the tapered, middle portion of the throat, and thus reaching the shredding mechanism.

In addition, the wider opening at the entrance of the throat helps facilitate the entry of paper, while the wider opening at the exit of the throat is necessary to prevent a paper jam when the shredder operates in reverse mode. If the opening at the exit were narrow, and the shredder was operating in reverse mode, the paper would not be able to back-up through the throat. The paper would thus get stuck at the exit, resulting in a paper jam.

From the preceding descriptions, it is apparent that the devices currently being used have significant disadvantages and/or limitations. Thus, important aspects of the technology used in the field of invention remain amenable to useful refinement.

### SUMMARY OF THE INVENTION

The present invention relates to an apparatus that satisfies the need for a shredder safety throat that prevents fingers and other foreign objects from entering a shredder while at the same time facilitating operation of the shredder.

In one preferred embodiment, the shredder safety throat is tapered towards the middle section of the throat such that both the entrance and exit of the throat are wider than the middle. The width of the throat at the narrow middle section is such that a finger or other foreign object cannot pass through it and thus inadvertently reach the shredding mechanism.

The width of the throat entrance is wider such that paper and/or other materials to be shredded can be readily placed through the throat. The width of the throat exit is also wider to prevent paper from jamming while the shredder is in the reverse mode.

All of the foregoing operational principles and advantages of the present invention will be more fully appreciated upon consideration of the following detailed description with reference to the drawings.

### BRIEF DESCRIPTION OF THE DRAWINGS

The features and advantages of this invention are better understood with regard to the following drawings, description, and claims. The drawings consist of the following:

FIG. 1 is a cross sectional side view of a prior art apparatus.

FIG. 2 is a cross sectional side view of an apparatus embodying features of this invention.

FIG. 3 is a cross sectional side view of an apparatus embodying features of this invention.

### DETAILED DESCRIPTION OF THE INVENTION

The essential elements of a shredder are comprised of a base (not shown), a housing 1, and a shredder mechanism 2 which resides in the housing 1. The shredder mechanism 2 can be of any sort commonly known to those skilled in the art and is thus not described herein.

The housing 1 has an opening or throat 3 which passes through it and leads to the shredding mechanism 2. Material to be shredded is then fed through the throat 3 and into the shredding mechanism 2.

This invention discloses a shredder safety throat that helps prevent injuries from occurring while facilitating shredder operation.

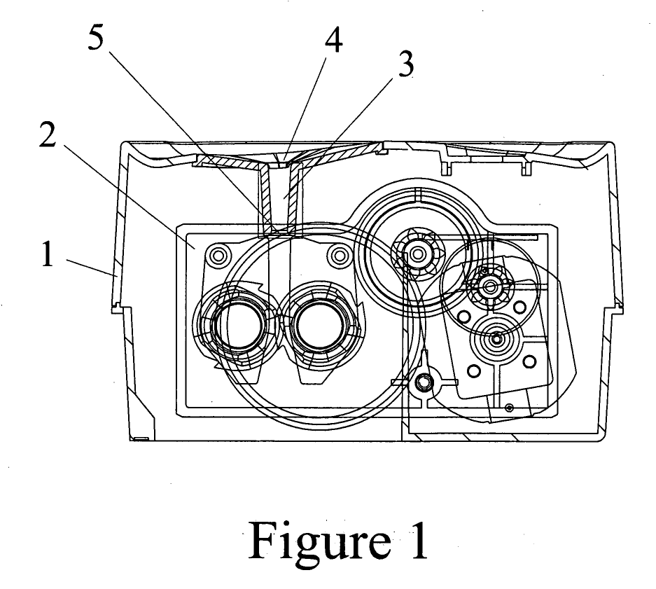

As seen in FIG. 1, prior art shredders commonly have a throat 3 that gradually tapers from the throat entrance 4 all the way through until the throat exit 5.

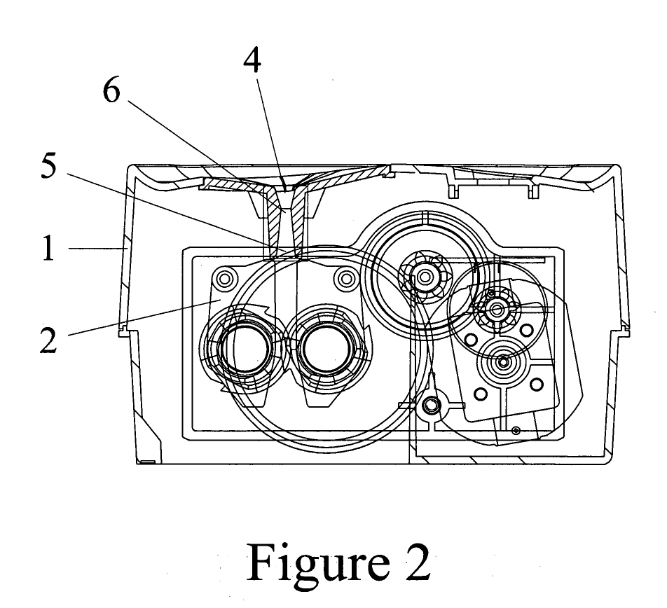

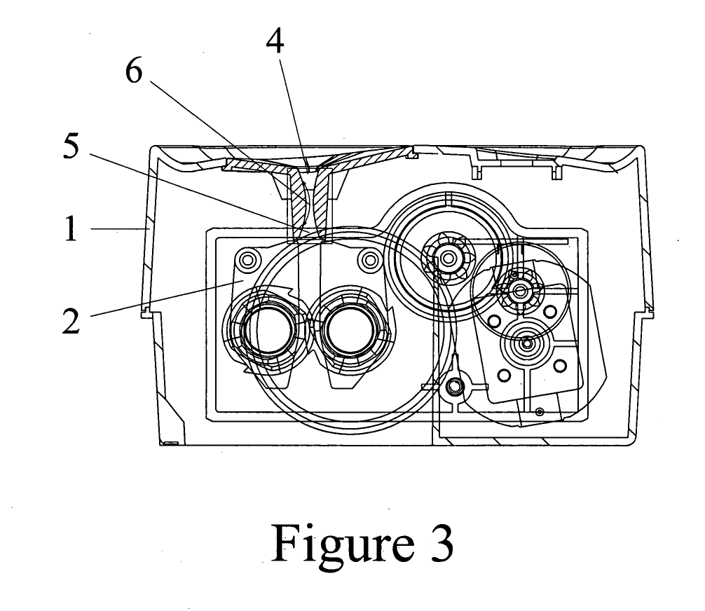

FIGS. 2 and 3 disclose the present invention whereby the shredder safety throat is tapered towards the middle section 6 of the throat such that both the throat entrance 4 and throat exit 5 are wider than the throat middle section 6. FIG. 3 discloses a more rounded tapering throat versus FIG. 2 which is more angular.

It should be appreciated that although the preferred embodiments disclosed herein show both a rounded and angular shredder safety throat, the scope of this invention is not limited to these two types of formations, and includes other embodiments whereby the center section of the throat is narrower than both the entrance and the exit, regardless of shape. In addition, although the preferred embodiments herein disclose a shredder throat that is part of the same mold or tooling as the housing, the shredder throat may also be a separate component entirely that may be connected with the housing or even inserted into an existing throat.

Thus, although the present invention has been described in detail with respect to certain preferred versions thereof, other versions are possible. Therefore, the scope of the claims should not be limited to the description of the preferred versions contained herein.

1. A shredder comprised of:
(a) a base;
(b) a housing;
(c) a shredding mechanism which resides in the housing;
(d) a throat through the housing leading to the shredding mechanism, the throat comprising a throat entrance through which material to be shredded enters the throat, a throat exit through which the material to be shredded reaches the shredding mechanism and a throat middle section connecting the throat entrance and the throat exit and containing a narrowing so that the throat entrance and throat exit are wider than the throat middle section.

2. The shredder of claim 1, wherein the narrowing is integral with the throat.

3. The shredder of claim 1, wherein a separate component is inserted into the throat in a fixed position to narrow the middle section of the throat.
